(19) United States
(12) Patent Application Publication
(10) Pub. No.: US 2016/0170404 A1
(43) Pub. Date: Jun. 16, 2016

(54) TOOL LIFE MANAGING APPARATUS FOR STEPPED TOOL

(71) Applicant: DMG MORI CO., LTD., Yamatokoriyama-shi (JP)

(72) Inventor: Tetsushi ASADA, Yamatokoriyama-shi (JP)

(21) Appl. No.: 14/969,991

(22) Filed: Dec. 15, 2015

(30) Foreign Application Priority Data
Dec. 16, 2014 (JP) 2014-254159

(51) Int. Cl. G05B 19/4065; B23Q 17/09

(52) U.S. Cl. CPC G05B 19/4065; B23Q 17/0995; G05B 2219/37252

(57) ABSTRACT

Provided is a tool life managing apparatus for a stepped tool capable of appropriately managing the tool life of each blade provided to the stepped tool and reducing cost and work for blade replacement. A tool life managing apparatus 1 manages the tool life of a stepped tool 10 provided with a plurality of replaceable blades in a multi-stage manner, and includes: a blade data storing unit 32 that stores, for each of the plurality of blades, a threshold concerning the tool life of the blade, an evaluation value indicating the degree of use at present of the blade, and a level distance from a leading-end blade; an accumulated machining count value acquiring unit 45 that acquires accumulated machining count values of a working machine 5 before and after machining by the stepped tool 10; an evaluation value updating unit 46 that updates the evaluation value of each blade on the basis of the accumulated machining count values, the evaluation value, and the level distance; and an evaluation value determining unit 47 that determines whether or not the updated evaluation value reaches the threshold.

### BACKGROUND OF THE INVENTION

1. Field of the Invention

The present invention relates to a tool life managing apparatus for a stepped tool that manages the tool life of a stepped tool provided with a plurality of replaceable blades or inserts in a multi-stage manner.

2. Description of the Related Art

Up to now, in a working machine controlled by a machining program of a numerical control apparatus or the like, various machining processes are performed by a multi-edged tool provided with a plurality of blades. Compared with a single-edged tool, the multi-edged tool reduces the trouble of blade replacement, and thus is widely used at present. Meanwhile, in the multi-edged tool, the frequency of use is different for each blade in accordance with machining types, and hence techniques of managing the tool life for each blade have been proposed.

For example, Japanese Patent Laid-Open No. 7-314290 proposes a tool life managing apparatus including: storage means for setting and storing in advance a tool life for each blade of a multi-edged tool and updating and storing an accumulated use time up to the present for each blade; remaining tool life computing means for computing, when a machining work command is outputted, a remaining tool life for each blade on the basis of tool life data and accumulated use time data; and determination means for: comparing a use time in this work according to the machining work command with the remaining tool life, for each blade; machining a workpiece in a case where the use time in this work does not exceed the remaining tool life for all the blades, and updating the accumulated use time with the use time in this work; and determining that the multi-edged tool comes to an end of the tool life in a case where the use time in this work exceeds the remaining tool life for at least one blade.

Although Japanese Patent Laid-Open No. 7-314290 proposes an invention targeting at the multi-edged tool provided with the plurality of blades, it is assumed that any one of the blades is used at the time of machining, and it is not assumed that the plurality of blades are used at the same time. Hence, the accumulated cutting time of a working machine counted by an NC apparatus is acquired at each of the start and the end of using each blade, and the difference therebetween is merely determined as the use time of the blade.

Meanwhile, multi-edged tools include a stepped tool provided with a plurality of blades in a multi-stage manner as illustrated in FIG. 8, and the stepped tool is used to form a hole with concentric steps having different diameters in a workpiece. The stepped tool has an advantage that tools having different diameters do not need to be called for machining several times and that the machining time can thus be shortened.

When a stepped hole is formed by the stepped tool, machining is started from a leading-end blade, subsequent blades are sequentially used as the stepped hole becomes deeper, and a plurality of blades or all the blades are finally used at the same time. Hence, conventional tool life managing techniques including Japanese Patent Laid-Open No. 7-314290 have a problem that the tool life of each blade provided to the stepped tool cannot be individually managed.

Moreover, the positional relation among the blades provided to the stepped tool does not change, and hence it is sufficient to set the leading-end blade as a machining command point designated on a machining program of a numerical control apparatus. In the first place, the cutting start timing for each blade is not set even on the machining program, and cannot be known.

Further, in recent years, in spite of the fact that the blades of the stepped tool are replaceable, tool life management for each blade cannot be achieved at present as described above. Hence, when the most frequently used leading-end blade comes to the end of its tool life, even the still usable subsequent blades are replaced for the sake of safety. Accordingly, there is a problem that unnecessary cost and work occur.

The present invention, which has been made in order to solve the above-mentioned problems, has an object to provide a tool life managing apparatus for a stepped tool capable of appropriately managing the tool life of each blade provided to the stepped tool and reducing cost and work for blade replacement.

### SUMMARY OF THE INVENTION

A tool life managing apparatus for a stepped tool according to the present invention manages a tool life of the stepped tool provided with a plurality of replaceable blades in a multi-stage manner, and includes: a blade data storing unit that stores, for each of the plurality of blades, a threshold concerning a tool life of the blade, an evaluation value indicating a degree of use at present of the blade, and a level distance from a leading-end blade; an accumulated machining count value acquiring unit that acquires accumulated machining count values of a working machine before and after machining by the stepped tool; an evaluation value updating unit that updates the evaluation value of each blade on the basis of the accumulated machining count values, the evaluation value, and the level distance; and an evaluation value determining unit that determines whether or not the updated evaluation value reaches the threshold.

Moreover, according to an aspect of the present invention, the tool life managing apparatus may further include: a first threshold processing unit that executes, when the evaluation value reaches a first threshold, any one of: a warning output process of outputting a warning for prompting replacement of the blade corresponding to the evaluation value; and an end-of-life process of prohibiting machining by the working machine and/or automatically replacing the blade corresponding to the evaluation value with a backup blade; and a second threshold processing unit that executes, when the evaluation value reaches a second threshold set on the basis of the first threshold, the other of the warning output process and the end-of-life process.

Further, according to an aspect of the present invention, the evaluation value updating unit may calculate the evaluation value according to the following Expression (1).

En=E0+a×(C2−C1)×(Lmax−Ln)/(Lmax) Expression (1)

where
En: the evaluation value of an n^{th}-step blade
E0: the evaluation value before the update
a: an evaluation factor
C1: the accumulated machining count value before the machining
C2: the accumulated machining count value after the machining
Lmax: a maximum machining distance
Ln: the level distance of the n^{th}-step blade

Moreover, according to an aspect of the present invention, the evaluation value updating unit may acquire a feed speed at the time of the machining by the stepped tool, and may calculate the evaluation value according to the following Expression (2).

En=E0+a×[(C2−C1)−(Ln/V)] Expression (2)

where
En: the evaluation value of an n^{th}-step blade
E0: the evaluation value before the update
a: an evaluation factor
C1: the accumulated machining count value before the machining
C2: the accumulated machining count value after the machining
Ln: the level distance of the n^{th}-step blade
V: the feed speed

Further, according to an aspect of the present invention, the tool life managing apparatus may further include: an input screen displaying unit that interactively displays an input screen for acquiring data used to manage the tool life of the stepped tool, onto display means; a blade data acquiring unit that acquires the level distance inputted to the input screen, and stores the acquired blade data into the blade data storing unit; and a blade data displaying unit that displays the acquired blade data onto the display means.

Moreover, according to an aspect of the present invention, the threshold or the evaluation value provided to each of the plurality of blades may be set to a value inversely proportional to a distance from an axial core of the stepped tool to the blade.

According to the present invention, it is possible to appropriately manage the tool life of each blade provided to the stepped tool and reduce cost and work for blade replacement.

### BRIEF DESCRIPTION OF THE DRAWINGS

FIG. 1 is a block diagram illustrating an embodiment of a tool life managing apparatus for a stepped tool according to the present invention;

FIG. 2 is a diagram illustrating an example of blade data in the present embodiment;

FIG. 3 is a schematic diagram illustrating a stepped tool of the present embodiment;

FIG. 4 is an example of a screen for registering tool data in association with each magazine in which a tool is stored, in the present embodiment;

FIG. 5 is an example of a screen for registering every data concerning one tool, in the present embodiment;

FIG. 6 is an example of a screen for registering the blade data, in the present embodiment;

FIG. 7 is a flowchart illustrating an operation of a tool life managing apparatus for a stepped tool in the present embodiment; and

FIG. 8 is a schematic diagram illustrating a general stepped tool and a stepped hole.

### DETAILED DESCRIPTION OF THE PREFERRED EMBODIMENTS

Hereinafter, an embodiment of a tool life managing apparatus for a stepped tool according to the present invention is described with reference to the drawings. Note that, in the present invention, a stepped tool 10 is a concept including all types of tool provided with a plurality of replaceable blades or inserts in a multi-stage manner.

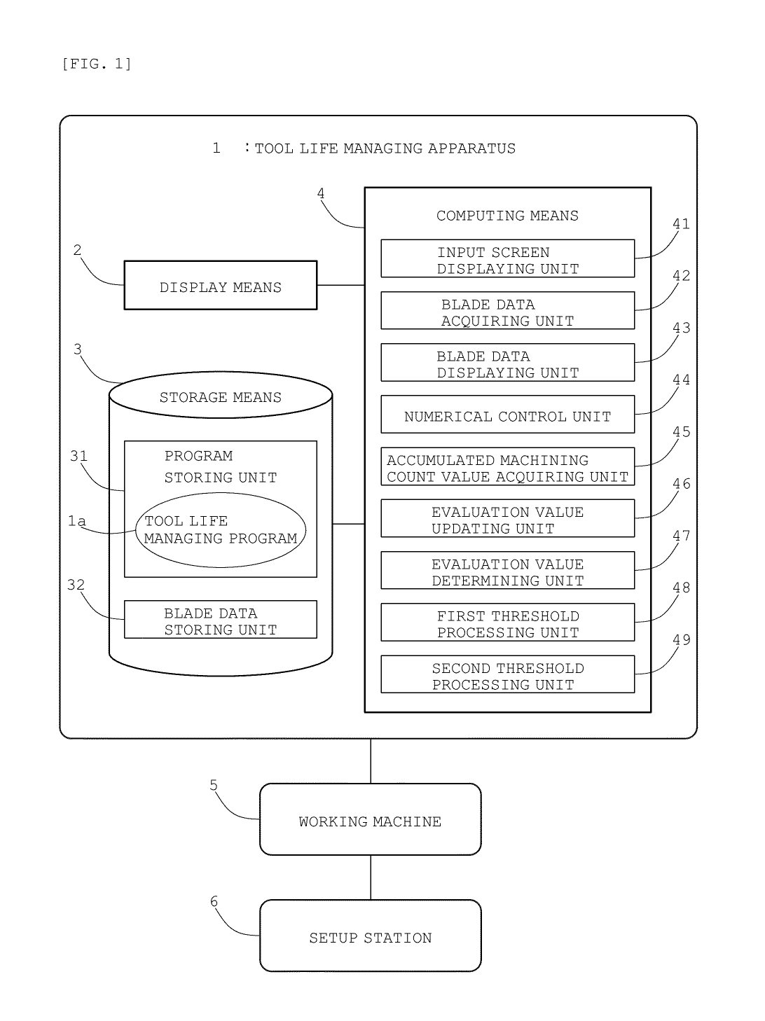

A tool life managing apparatus 1 for a stepped tool of the present embodiment is configured by a numerical control apparatus such as a computer numerical control (CNC) apparatus. As illustrated in FIG. 1, the tool life managing apparatus 1 mainly includes: display means 2 for displaying various screens; storage means 3 for storing a tool life managing program 1a of the present embodiment and blade data; and computing means 4 for executing various computing processes and functioning as each constituent unit to be described later. Moreover, a working machine 5 controlled by the tool life managing apparatus 1 and a setup station 6 for replacing tools in the working machine 5 are provided. Hereinafter, each configuration is described in detail.

The display means 2 is configured by a liquid crystal display and the like, and displays an interactive input screen, a browser screen of registered blade data, and other such screens to be described later.

The storage means 3 stores various pieces of data, and functions as a working area when the computing means 4 performs a computing process. In the present embodiment, the storage means 3 is configured by a hard disk, a read only memory (ROM), a random access memory (RAM), a flash memory, and the like, and includes a program storing unit 31 and a blade data storing unit 32 as illustrated in FIG. 1.

The tool life managing program 1a for controlling the tool life managing apparatus 1 of the present embodiment is installed in the program storing unit 31. Then, the computing means 4 executes the tool life managing program 1a, to thereby cause a computer as the tool life managing apparatus 1 to function as each constituent unit to be described later. Note that, in the present embodiment, the tool life managing program 1a is configured by adding a tool life managing function according to the present invention to a machining program used in a general numerical control apparatus.

Moreover, the utilization form of the tool life managing program 1a is not limited to the above-mentioned configuration. For example, the tool life managing program 1a may be stored in a computer-readable recording medium such as a CD-ROM and a DVD-ROM, and may be executed by being read out directly from the recording medium. Alternatively, the tool life managing program 1a may be utilized through an application service provider (ASP) system or a cloud computing system from an external server or the like.

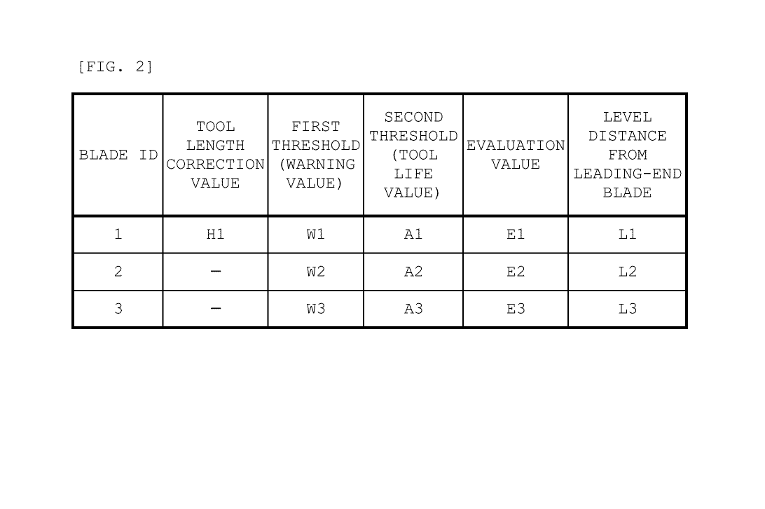

The blade data storing unit 32 stores data concerning each of the plurality of blades provided to the stepped tool 10. In the present embodiment, as illustrated in FIG. 2, the blade data storing unit 32 stores, in association with each of the plurality of blades: a blade ID for identifying the blade; a tool length correction value for determining a leading-end blade; thresholds (a first threshold and a second threshold) concerning the tool life of the blade; an evaluation value indicating the degree of use at present of the blade; and a level distance from the leading-end blade.

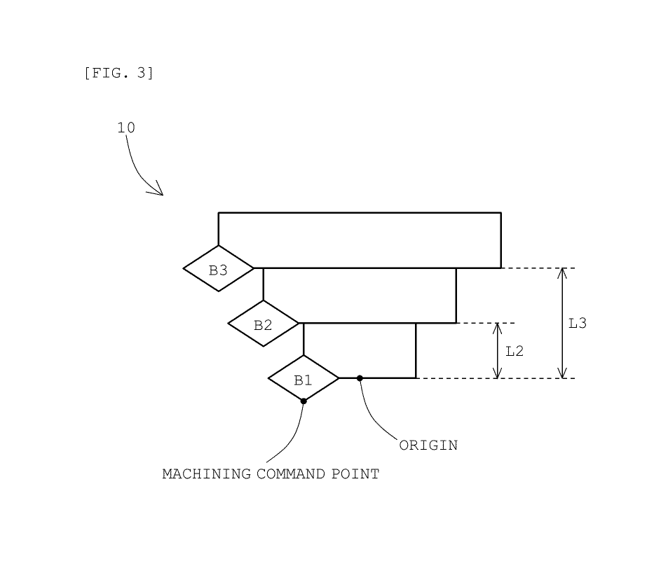

Note that, as illustrated in FIG. 3, the present embodiment uses the stepped tool 10 having three steps to which a replaceable blade B1, a replaceable blade B2, and a replaceable blade B3 are respectively provided, but is not limited to this configuration. That is, the stepped tool 10 may have two steps and may have four or more steps, as long as the stepped tool 10 is provided with a plurality of replaceable blades in a multi-stage manner.

The blade ID is used to identify each blade, and corresponds to each step number of the stepped tool 10 in the present embodiment. That is, the blade ID of the first-step blade is set to 1, the blade ID of the second-step blade is set to 2, and the blade ID of the third-step blade is set to 3. The tool length correction value is used to determine a machining command point for the stepped tool 10. In the present embodiment, the leading-end blade provided to the first step is set as the machining command point, and hence the XYZ-directional distance from the origin of the stepped tool 10 to the leading-end blade is registered as illustrated in FIG. 3.

The first threshold and the second threshold are thresholds concerning the tool life of each blade. In the present embodiment, warning values W1 to W3 that define the timing of outputting a warning for prompting blade replacement are stored as the first threshold. Moreover, tool life values A1 to A3 that define the timing of prohibiting machining by the working machine 5 and/or the timing of automatically replacing the blade with a backup blade are stored as the second threshold.

Note that, in the present embodiment, the relation “the second threshold=the first threshold+a predetermined value” is defined in advance, and hence the second threshold is automatically set on the basis of the first threshold by registering only the first threshold. Not limited to this configuration, the first threshold and the second threshold may be registerable independently of each other. Alternatively, the warning values may be stored as the second threshold, and the tool life values may be stored as the first threshold.

Evaluation values E1 to E3 are values indicating the degree of use at present of each blade. In the present embodiment, evaluation values calculated on the basis of the machining time and the number of times of machining as accumulated machining count values obtained from the working machine 5 are stored as described later. Level distances L1 to L3 are data indicating the distance from the leading-end blade, and are stored for each blade. Hence, the level distance of the leading-end blade (the blade ID=1) is set to 0.

The computing means 4 executes various computing processes on the basis of various pieces of data stored in the storage means 3. In the present embodiment, the computing means 4 is configured by a central processing unit (CPU) and the like, and executes the tool life managing program 1a installed in the storage means 3, to thereby cause the tool life managing apparatus 1 to function as an input screen displaying unit 41, a blade data acquiring unit 42, a blade data displaying unit 43, a numerical control unit 44, an accumulated machining count value acquiring unit 45, an evaluation value updating unit 46, an evaluation value determining unit 47, a first threshold processing unit 48, and a second threshold processing unit 49 as illustrated in FIG. 1. Hereinafter, each constituent unit is described more in detail.

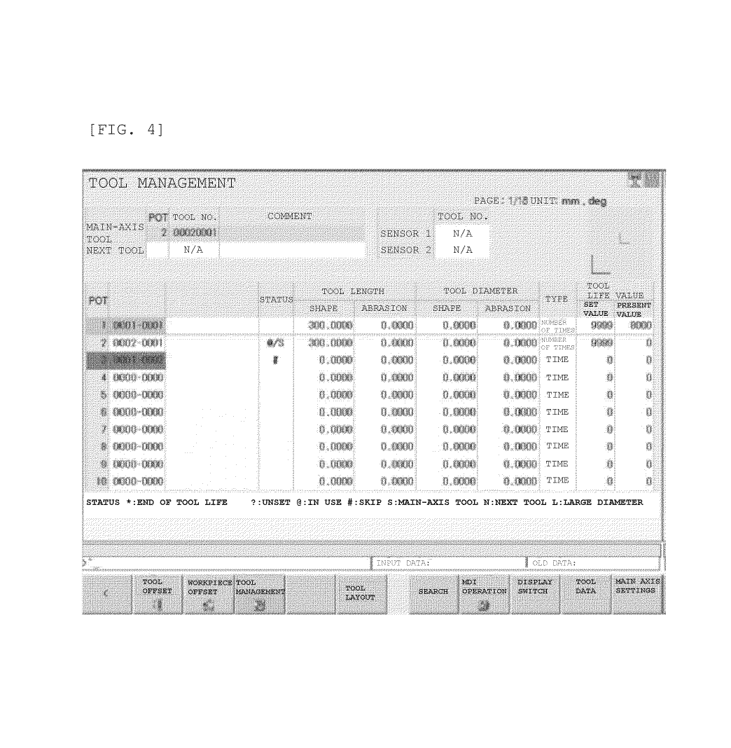

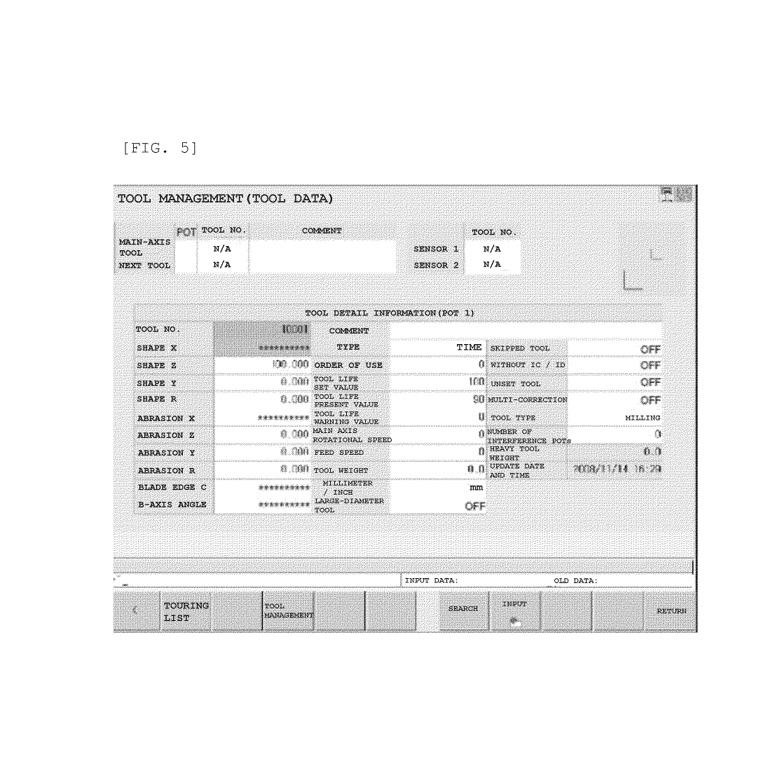

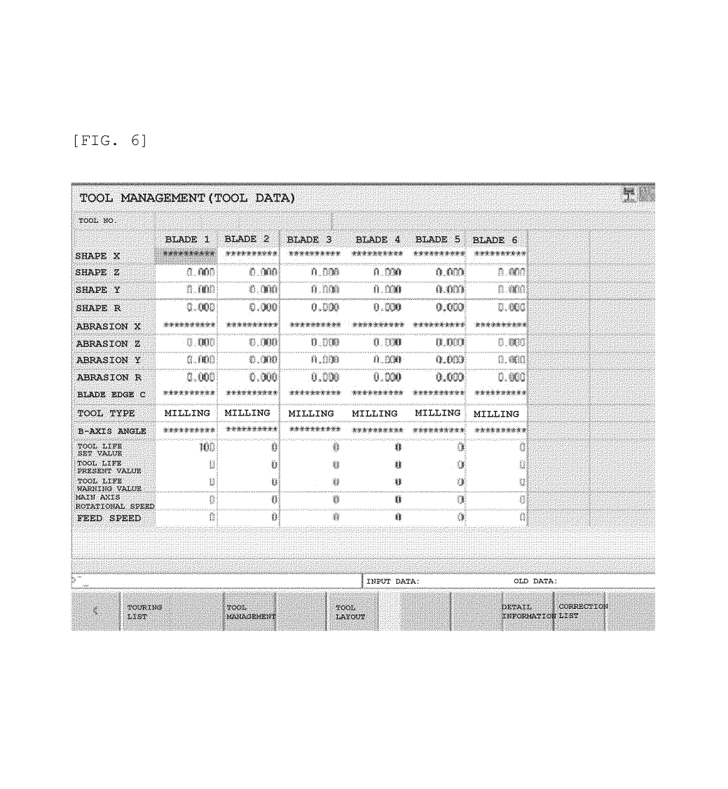

The input screen displaying unit 41 interactively displays an input screen for acquiring data used to manage the tool life of the stepped tool 10, onto the display means 2. In the present embodiment, the input screen displaying unit 41 displays: an input screen for registering tool data in association with each magazine (POTs 1 to 10) in which a tool is stored, as illustrated in FIG. 4; an input screen for registering every data concerning one tool, as illustrated in FIG. 5; and an input screen for registering the above-mentioned blade data, as illustrated in FIG. 6. Moreover, at the time of inputting various pieces of data, character or voice messages such as “please input the step number of the stepped tool” and “please input the level distance from the leading-end blade” are outputted to a user, whereby an interactive input method is adopted.

The blade data acquiring unit 42 acquires various pieces of data inputted to the input screens, and stores the acquired data into the blade data storing unit 32. In the present embodiment, the blade data acquiring unit 42 acquires the level distance, the tool length correction value, and the like through the input screens, and stores the acquired data into the blade data storing unit 32.

The blade data displaying unit 43 displays the acquired blade data onto the display means 2. Specifically, as illustrated in FIG. 4 to FIG. 6, the blade data displaying unit 43 displays a list of pieces of data concerning each tool and a list of pieces of data on each blade provided to the stepped tool 10, and enables the user to browse the displayed lists.

The numerical control unit 44 executes various numerical control processes executed by a general machining program. Specifically, examples thereof include a tool call command, a tool replacement command, a next-tool call command, a tool length correction value read-in command, a positioning command (approach, escape), and a machining command.

The accumulated machining count value acquiring unit 45 acquires accumulated machining count values of the working machine 5 before and after machining by the stepped tool 10. In the present invention, the accumulated machining count value is a concept including all types of accumulated value counted along with machining by the stepped tool 10, such as the accumulated machining time counted for the working machine 5 and the accumulated number of times of machining counted for each block of the machining program.

The evaluation value updating unit 46 updates the evaluation value of each blade on the basis of the accumulated machining count values, the evaluation value, and the level distance. In the present embodiment, the evaluation value updating unit 46 calculates the evaluation value according to the following Expression (1) including a count value (C2−C1) corresponding to an amount increased during machining by the stepped tool 10.

En=E0+a×(C2−C1)×(Lmax−Ln)/(Lmax) Expression (1)

where
En: the evaluation value of an n^{th}-step blade
E0: the evaluation value before the update
a: an evaluation factor
C1: the accumulated machining count value before the machining
C2: the accumulated machining count value after the machining
Lmax: a maximum machining distance
Ln: the level distance of the n^{th}-step blade

Alternatively, in the present embodiment, the evaluation value updating unit 46 may acquire a feed speed at the time of machining by the stepped tool 10 from the tool life managing program 1a, and may calculate the evaluation value according to the following Expression (2) including the count value (C2−C1) corresponding to the amount increased during the machining by the stepped tool 10.

En=E0+a×[(C2−C1)−(Ln/V)] Expression (2)

where
En: the evaluation value of an n^{th}-step blade
E0: the evaluation value before the update
a: an evaluation factor
C1: the accumulated machining count value before the machining
C2: the accumulated machining count value after the machining
Ln: the level distance of the n^{th}-step blade
V: the feed speed

Note that the maximum machining distance in the above Expression (1) is a value indicating the movement distance at the time of machining by a predetermined stepped tool 10. The maximum machining distance may be set in advance by the user on the basis of the movement distance at the time of the machining set to the tool life managing program 1a. Alternatively, the evaluation value updating unit 46 may acquire the feed speed at the time of the machining by the stepped tool 10 from the tool life managing program 1a, and may calculate the maximum machining distance by multiplying the feed speed by a difference in accumulated machining time.

Moreover, the evaluation factor in each of the above Expressions (1) and (2) is calculated as appropriate depending on machining conditions such as the material of a workpiece and the feed speed. This is because the tool life of a tool is greatly different depending on the material of a workpiece, the feed speed, and the like, even if the cutting time is the same. For example, a material factor determined by the material of a workpiece may be set to a larger value as the hardness of the material becomes higher while being set to a smaller value as the hardness thereof becomes lower, and the material factor thus set may be prepared in advance in a predetermined table.

The evaluation value determining unit 47 determines whether or not the evaluation value updated by the evaluation value updating unit 46 reaches a threshold. In the present embodiment, the first threshold as a “warning value” and the second threshold as a “tool life value” are set as described above, the “warning value” defining the timing of outputting a warning for prompting blade replacement, the “tool life value” defining the timing of prohibiting machining by the working machine 5 and/or the timing of automatically replacing the blade with a backup blade.

Accordingly, the evaluation value determining unit 47 compares the evaluation value updated by the evaluation value updating unit 46 with the warning value and the tool life value registered in the blade data storing unit 32. Then, the evaluation value determining unit 47 determines whether or not the evaluation value reaches the warning value, and determines whether or not the evaluation value reaches the tool life value.

The first threshold processing unit 48 executes, when the evaluation value reaches the warning value (first threshold), a warning output process of outputting a warning for prompting replacement of the blade corresponding to the evaluation value. Specifically, the warning output process includes outputting a command signal for displaying a warning screen onto the display means 2 or for outputting a warning alarm from a speaker (not illustrated) or the like.

The second threshold processing unit 49 executes an end-of-life process when the evaluation value reaches the tool life value (second threshold). Specifically, the end-of-life process includes outputting a command signal for prohibiting machining by the working machine 5 and/or for automatically replacing the blade corresponding to the evaluation value with a backup replacement blade.

Note that, in the case where the tool life value is stored as the first threshold while the warning value is stored as the second threshold, the above-mentioned processes respectively executed by the first threshold processing unit 48 and the second threshold processing unit 49 replace each other. That is, the first threshold processing unit 48 and the second threshold processing unit 49 execute any one of the warning output process and the end-of-life process and the other thereof.

The working machine 5 is a machine such as a lathe, a drilling machine, a boring machine, a milling machine, a gear cutting machine, and a grinding machine, for subjecting metal, wood, stone, resin, and other materials to machining such as cutting, boring, grinding, polishing, rolling, forging, and bending. The working machine 5 includes a magazine (not illustrated) for attaching the stepped tool 10 or other tools.

The setup station 6 replaces the tool attached to the magazine of the working machine 5. In the present embodiment, in the case where a given blade comes to the end of its tool life, a tool provided with the given blade is transported from the magazine of the working machine 5 to the setup station 6, and is detached. After the given blade is replaced with a new blade, the tool is attached to the setup station 6, and is transported to the magazine. Moreover, the evaluation value of the new blade after the replacement is set to zero and initialized in the blade data storing unit 32.

Next, actions of the tool life managing apparatus 1 for the stepped tool, the tool life managing program 1a, and a tool life managing method of the present embodiment are described.

First, in the case where the tool life of the stepped tool 10 is managed according to the tool life managing method implemented by the tool life managing apparatus 1 for the stepped tool and the tool life managing program 1a of the present embodiment, various pieces of data are registered in advance. At the time of registering the data, the input screen displaying unit 41 interactively displays the input screen for acquiring data used to manage the tool life of the stepped tool 10, onto the display means 2. This enables even a user unfamiliar with how to operate the tool life managing apparatus 1 to easily and promptly input the necessary data.

The various pieces of data that are inputted by the user into the input screen are acquired by the blade data acquiring unit 42, and are registered into the blade data storing unit 32. Moreover, the various pieces of registered blade data are displayed by the blade data displaying unit 43 onto the display means 2 as illustrated in FIG. 4 to FIG. 6. This enables the user to check or browse the registered blade data at any time.

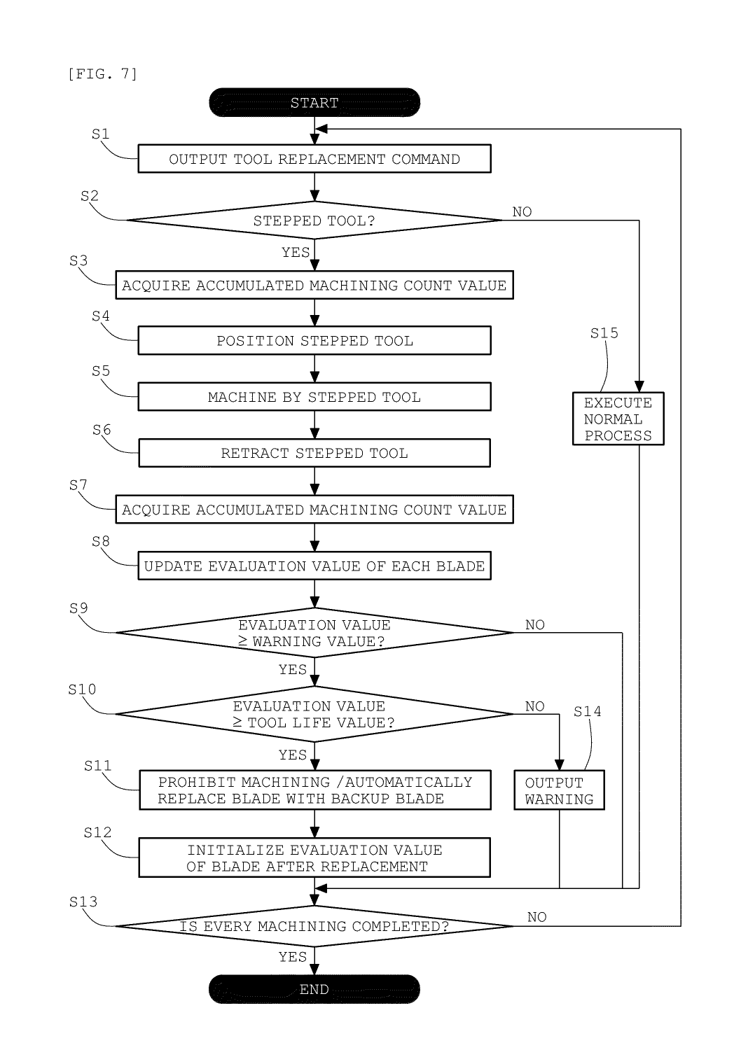

Next, upon the start of machining by the tool life managing apparatus 1 for the stepped tool of the present embodiment, as illustrated in FIG. 7, the numerical control unit 44 outputs a tool replacement command (Step S1). As a result, the stepped tool 10 or other tools is attached to the magazine of the working machine 5.

If the attached tool is not the stepped tool 10 (Step S2: NO), the numerical control unit 44 causes the working machine 5 to execute a normal machining process (Step S15). On the other hand, if the attached tool is the stepped tool 10 (Step S2: YES), the accumulated machining count value acquiring unit 45 acquires the accumulated machining count value of the working machine 5 (Step S3). As a result, the accumulated machining count value before the start of the machining by the stepped tool 10 is obtained.

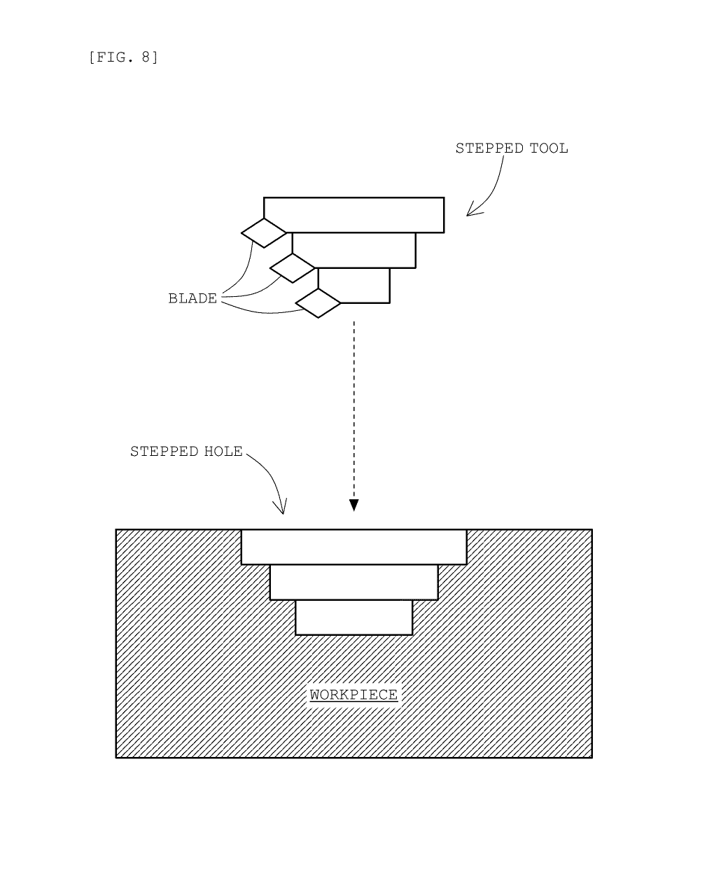

Subsequently, similarly to other tools, the numerical control unit 44 executes positioning of the stepped tool 10 (Step S4), the machining by the stepped tool 10 (Step S5), and retraction of the stepped tool 10 (Step S6). As a result, such a stepped hole as illustrated in FIG. 8 is formed in a workpiece.

Upon the end of the machining by the stepped tool 10, the accumulated machining count value acquiring unit 45 acquires the accumulated machining count value of the working machine 5 again (Step S7). As a result, the accumulated machining count value after the end of the machining by the stepped tool 10 is obtained. Hence, the difference in accumulated machining count value between before and after the machining is calculated, whereby the count value (C2−C1) corresponding to the amount increased during the machining by the stepped tool 10 is obtained.

Subsequently, the evaluation value updating unit 46 updates the evaluation value of each blade using the above Expression (1) or the above Expression (2) (Step S8). In response to this, the evaluation value determining unit 47 determines whether or not the updated evaluation value reaches the warning value (Step S9). As a result of the determination, if the evaluation value is smaller than the warning value (Step S9: NO), the processing proceeds directly to Step S13 to be described later. On the other hand, if the evaluation value is equal to or larger than the warning value (Step S9: YES), the evaluation value determining unit 47 determines whether or not the evaluation value also reaches the tool life value (Step S10).

As a result of the determination, if the evaluation value is smaller than the tool life value (Step S10: NO), the first threshold processing unit 48 outputs a warning for prompting replacement of the blade corresponding to the evaluation value (Step S14). This enables the user to know that the blade comes to the end of its tool life soon and to prepare a backup replacement blade in advance or replace the blade with a new blade well in advance.

On the other hand, if the evaluation value is equal to or larger than the tool life value (Step S10: YES), the second threshold processing unit 49 prohibits the machining by the working machine 5, and/or automatically replaces the blade corresponding to the evaluation value with a backup replacement blade (Step S11). As a result, the blade that has come to the end of its tool life can be prevented from being erroneously used for the machining, and is automatically replaced with a new blade. Moreover, the evaluation value of the new blade after the replacement is initialized in the blade data storing unit 32 (Step S12).

After that, the above-mentioned steps are repeated until every machining is completed (Step S13). Similarly, after Step S14 (warning output process) and Step S15 (normal process), the processing also proceeds to Step S13, and the above-mentioned steps are repeated until every machining is completed.

The present embodiment configured as described above produces the following effects.

1. The tool life of each blade provided to the stepped tool 10 can be appropriately managed, and cost and work for blade replacement can be reduced.

2. Because the tool life of each blade can be individually managed, a blade beyond its tool life can be prevented from being erroneously used, and the machining quality can be maintained.

3. Data used to manage the tool life of the stepped tool 10 can be easily and promptly inputted through an interactive user interface.

Note that the tool life managing apparatus 1 for the stepped tool according to the present invention is not limited to the above-mentioned embodiment, and can be changed as appropriate.

For example, in the present embodiment, the distance from the axial core of the stepped tool 10 to each blade is not considered at the time of setting the thresholds such as the warning value and the tool life value and the evaluation factor. However, even if blades have the same accumulated machining count value, as the distance from the axial core becomes larger, the degree of abrasion becomes higher. Hence, the thresholds or the evaluation factor provided to each of the plurality of blades may be set to a value inversely proportional to the distance from the axial core of the stepped tool 10 to the blade. With this configuration, the tool life of the blade can be managed with higher accuracy.

Moreover, in the present embodiment, the tool life managing apparatus 1 for the stepped tool doubles as the numerical control apparatus, but the present invention is not limited to this configuration. That is, the tool life managing apparatus 1 for the stepped tool and the numerical control apparatus may be provided independently of each other.

What is claimed is:

1. A tool life managing apparatus for a stepped tool that manages a tool life of the stepped tool provided with a plurality of replaceable blades in a multi-stage manner, the apparatus comprising:
a blade data storing unit that stores, for each of the plurality of blades, a threshold concerning a tool life of the blade, an evaluation value indicating a degree of use at present of the blade, and a level distance from a leading-end blade;
an accumulated machining count value acquiring unit that acquires accumulated machining count values of a working machine before and after machining by the stepped tool;
an evaluation value updating unit that updates the evaluation value of each blade on the basis of the accumulated machining count values, the evaluation value, and the level distance; and
an evaluation value determining unit that determines whether or not the updated evaluation value reaches the threshold.

2. The tool life managing apparatus for the stepped tool according to claim 1, further comprising:
a first threshold processing unit that executes, when the evaluation value reaches a first threshold, any one of: a warning output process of outputting a warning for prompting replacement of the blade corresponding to the evaluation value; and an end-of-life process of prohibiting machining by the working machine and/or automatically replacing the blade corresponding to the evaluation value with a backup blade; and
a second threshold processing unit that executes, when the evaluation value reaches a second threshold set on the basis of the first threshold, the other of the warning output process and the end-of-life process.

3. The tool life managing apparatus for the stepped tool according to claim 1, wherein the evaluation value updating unit calculates the evaluation value according to the following Expression (1).
En=E0+a×(C2−C1)×(Lmax−Ln)/(Lmax) Expression (1)
where
En: the evaluation value of an n^{th}-step blade
E0: the evaluation value before the update
a: an evaluation factor
C1: the accumulated machining count value before the machining
C2: the accumulated machining count value after the machining
Lmax: a maximum machining distance
Ln: the level distance of the n^{th}-step blade

4. The tool life managing apparatus for the stepped tool according to claim 1, wherein the evaluation value updating unit acquires a feed speed at the time of the machining by the stepped tool, and calculates the evaluation value according to the following Expression (2).
En=E0+a×[(C2−C1)−(Ln/V)] Expression (2)
where
En: the evaluation value of an n^{th}-step blade
E0: the evaluation value before the update
a: an evaluation factor
C1: the accumulated machining count value before the machining
C2: the accumulated machining count value after the machining
Ln: the level distance of the n^{th}-step blade
V: the feed speed

5. The tool life managing apparatus for the stepped tool according to claim 1, further comprising:
an input screen displaying unit that interactively displays an input screen for acquiring data used to manage the tool life of the stepped tool, onto display means;
a blade data acquiring unit that acquires the level distance inputted to the input screen, and stores the acquired blade data into the blade data storing unit; and
a blade data displaying unit that displays the acquired blade data onto the display means.

6. The tool life managing apparatus for the stepped tool according to claim 1, wherein the threshold or the evaluation value provided to each of the plurality of blades is set to a value inversely proportional to a distance from an axial core of the stepped tool to the blade.
